(19) United States
(12) Patent Application Publication
(10) Pub. No.: US 2011/0135829 A1
(43) Pub. Date: Jun. 9, 2011

(54) ESTER-BASED CONCRETE SURFACE RETARDERS

(76) Inventors: Dany Vincent, Chateaurenaud (FR); Eric Dananche, Courlaoux (FR); Ralf Quern, Bad Pyrmont (DE); Byong-wa Chun, Newton, MA (US)

(21) Appl. No.: 13/058,410

(22) PCT Filed: Aug. 19, 2009
(86) PCT No.: PCT/IB2009/006578

§ 371 Date: Feb. 10, 2011

(30) Foreign Application Priority Data
Aug. 21, 2008 (FR) 08/04664

(51) Int. Cl. B05D 3/10

(52) U.S. Cl. 427/337

(57) ABSTRACT

Compositions and methods of the invention for retarding the surface of a concrete or other hydratable cementitious composition involve the use of at least one alkyl-ester-of-hydroxycarboxy compound contained in the form of particles or as a discontinuous phase distributed within a continuous non-aqueous carrier phase that is spray-applicable in liquid form. The set retarder helps to achieve lower pH and to avoid irritating fogs during spray application of the surface retarder when compared to prior art acid-containing surface retarders.

### FIELD OF THE INVENTION

The present invention relates to retarding of concrete surfaces, and particularly to surface retarder compositions comprising oil/solvent-soluble or oil-dispersible alkyl-ester-of-hydroxycarboxy compounds for concrete, mortar, and other hydratable cementitious material applications.

### BACKGROUND OF THE INVENTION

Surface retarders are compositions used for treating the surface of cement and concrete compositions. For example, fresh concrete containing aggregates is poured and leveled, and then the retarder is sprayed as an aqueous solution onto the surface at a rate of about 200 g/m². After a number of hours, the treated surface may be washed off with a high pressure water jet to remove uncured cement and to expose the aggregates on the surface.

U.S. Pat. No. 7,037,367 B2 of Mauchamp et al. disclosed compositions wherein a surface retarder active (e.g., an acid-based compound including a malic, tartaric, citric, gluconic, or heptagluconic acid) was suspended in a vegetable oil derivative such as mono and diglycerides of C₆-C₃₀ fatty acids, esters of C₆-C₃₀ fatty acids, C₆-C₃₀ fatty alcohols, C₆-C₃₀ fatty amines, C₆-C₃₀ fatty amides, and tall oil derivatives. This permitted the spray application of a wet film coating that provided the retarder active with a favorable opportunity to penetrate into the cement surface for efficacious etching of the cement.

The present inventors believe that novel surface retarder compositions and methods are needed for obtaining pH neutrality, or at least for obtaining decreased acidity, in order to minimize the corrosive effects of acid-based retarders and to avoid irritating fogs when the retarder treatment is spray-applied onto the concrete, while still obtaining clear etches in the concrete surface.

It is an objective of the present invention to provide such novel compositions and methods.

### SUMMARY OF THE INVENTION

The present invention provides a novel surface retarder composition comprising at least one oil/solvent-soluble or oil-dispersible alkyl-ester-of-hydroxycarboxy compound, contained in the form of particles or as a discontinuous liquid phase, distributed within a continuous non-aqueous carrier phase that is spray-applicable in liquid form.

Exemplary alkyl-ester-of-hydroxycarboxy compounds of the invention may be selected from the group consisting of an alkyl ester of citric acid, an alkyl ester of tartaric acid, an alkyl ester of malic acid, an alkyl ester of gallic acid, an alkyl ester of glycolic acid, an alkyl ester of gluconic acid, an alkyl ester of lactic acid, an alkyl ester of mandelic acid, an alkyl ester of salicylic acid, and an alkyl ester of 4-hydroxybutanoic acid.

Preferred alkyl-ester-of-hydroxycarboxy compounds of the invention n have alpha-hydroxycarbonyl groups or alkyl-ester of hydroxycarboxylic acid. Most preferred are alkyl esters of citric acid (e.g., triethyl citrate) and alkyl esters of tartaric acid (e.g., diethyl tartarate).

The continuous non-aqueous oil/solvent or oil/carrier carrier liquid phase may comprise a petroleum-based solvent, a vegetable oil, an animal oil, or mixture or derivative thereof.

Exemplary methods of the invention comprise spray-applying said novel surface retarder compositions onto a surface of a concrete or mortar or other hydratable cementitious material, so as to retard the curing thereof. The portion of the surface of said cementitious material on which said retarder composition has been applied may then be removed by spraying a jet of water to remove the retarded portion of the surface material. The compositions may also be applied onto concrete molds before the concrete composition is poured into the molds and used as mold-release coatings.

The present invention is believed to provide advantages over the prior art in terms of permitting a pH level that is less acidic. Another advantage, where the ester-based retarder component is used in solid powder form, is that retarder particles can be easier to incorporate into the spray-applicable liquid carrier in the manufacturing process, because the raw material can be obtained in solid particles that do not require a time-consuming grinding step.

Further, the alkyl-ester-based hydroxycarboxy surface retarder compounds of the invention are believed to operate with enhanced activity as the pH of the concrete composition increases, thus conferring a “latent” retarding capability that is believed to achieve sharper etchings in the concrete material.

Conventional set retarders, pigments, fillers, and other ingredients may be mixed into the set retarder composition as desired.

Other features and advantages of the invention are described in greater detail hereinafter.

### DETAILED DESCRIPTION OF EXEMPLARY EMBODIMENTS

As used herein, the terms “cement” and “cementitious composition” (which are synonomous with “cement composition”) are understood to refer to pastes, mortars, and concrete compositions comprising a hydratable cement binder. The terms “paste”, “mortar” and “concrete” are terms of art: “pastes” are mixtures composed of a hydratable cement binder (usually, but not exclusively, Portland cement, masonry cement, or mortar cement, and this binder may also include limestone, hydrated lime, fly ash, granulated blast furnace slag, pozzolans, and silica fume or other materials commonly included in such cements) and water; “mortars” are pastes additionally including fine aggregate (e.g., sand), and “concretes” are mortars additionally including coarse aggregate (e.g., crushed gravel, stone). The cementitious compositions used in this invention may be formed by mixing required amounts of certain materials, e.g., a hydratable cement, water, and fine and/or coarse aggregate, as may be applicable to make the particular cement composition being formed.

All percentages of components described or claimed herein shall be in terms of total weight of the composition unless otherwise indicated.

As previously summarized, an exemplary surface retarder composition of the invention comprises at least one alkyl-ester-of-hydroxycarboxy compound, including partial and/or par esters, which is oil/solvent-soluble or oil-dispersible. Preferably, although not necessarily, such alkyl esters may be water-insoluble at ambient temperature, and have at least one or more terminal carboxylic acid (—COOH) groups. Most preferred are alkyl esters having alpha-hydroxycarbonyl group [—CR—(OH)—C(═)—] or alkyl-ester of hydroxycarboxylic acid.

Exemplary alky-ester-of-hydroxycarboxy compounds that are believed suitable for use in the invention are selected from the group consisting of an alkyl ester of citric acid (citric acid is otherwise known as 2-hydroxy-1,2,3-propanetricarboxylic acid, HOOCCH₂C(OH)(COOH)CH₂COOH.H₂O); an alkyl ester of tartaric acid (tartaric acid is otherwise known as dihydroxysuccinic acid, HOOC(CHOH)₂COOH); an alkyl ester of malic acid (malic acid is otherwise known as hydroxysuccinic acid, COOHCH₂CH(OH)COOH); an alkyl ester of gallic acid (gallic acid is otherwise known as 3,4,5-trihydroxybenzoic acid, C₆H₂(OH)₃COOH); an alkyl ester of glycolic acid (glycolic acid is otherwise known as hydroxyacetic acid, CH₂OHCOOH); an alkyl ester of gluconic acid (gluconic acid may be represented by the formula CH₂OH(CHOH)₄COOH); an alkyl ester of lactic acid (lactic acid may be represented by the formula CH₃CHOHCOOH); an alkyl ester of mandelic acid (mandelic acid may be represented by the formula, C₆H₅CHOHCOOH); an alkyl ester of salicylic acid (salicylic acid may be represented by the formula, C₆H₄(OH)COOH); and an alkyl ester of 4-hydroxybutanoic acid.

As previously mentioned, preferred alkyl ester surface retarder compounds of the invention include esters of citrate, tartarate, or mixtures thereof. It is believed by the inventors that a number of esters of citrates and tartarates are commercially available and are suitable for use in the invention. For example, methyl citrate and methyl tartarate, ethyl citrate and ethyl tartarate, and butyl citrate and butyl tartarate are commercially available. Also available is acetyltributylcitrate and dibenzyltartarate.

Given the fact that esters can be broken down by the alkaline environment of the cement in the concrete, the ethyl form (e.g., ethyl citrate, ethyl tartarate) is among the most preferred of these.

The alkyl-ester-containing hydroxycarboxy compositions of the invention are oil/solvent-soluble and/or oil-dispersible. In other words, they should be compatible with the non-aqueous, oil/solvent liquid or oil carrier liquid such that they can be dissolved within and/or carried as solid particles dispersed within the continuous non-aqueous carrier phase which is spray-applicable as a liquid.

The continuous liquid phase which functions as a carrier or solvent may be petroleum-based or derived from vegetable oil, animal oil, or a mineral oil, or derivative thereof, and is preferably spray-applicable at ambient temperature. The amount of the continuous oil carrier liquid (e.g., vegetable oil) or oil solvent (e.g., petroleum resin) is preferably 1-98% by total weight of the liquid-applicable surface retarder composition, more preferably 25-92% by total weight of the composition, and most preferably 50-90% by total weight of the composition.

The total amount of alkyl ester surface retarder component dispersed, dissolved, or otherwise distributed within the continuous liquid carrier phase, including any other compounds commonly used with surface retarders (e.g., pigments and fillers) is preferably contained in the range amount of 1%-20% based on total weight of the composition.

Where petroleum-based solvents or liquid carriers are not desired from an environmental standpoint, vegetable-oil based or mineral oil based liquid carriers may be employed, as disclosed in U.S. Pat. No. 7,037,367 B2 of Mauchamp et al. As defined therein, the term “vegetable oil” means a product (whether in liquid, paste, or solid form) extracted from the seeds, fruit, or nuts of plants and sap trees (such as hevea sap, maple, lignosulfonates, pinetree sap). Vegetable oils are generally considered to be a mixture of mixed glycerides (See e.g., Hawley's Condensed Chemical Dictionary, Ed. N. Irving Sax, Richard J. Lewis, Sr., 11th Ed. (Von Nostrand Reinhold Company, New York 1987), page 1219). Vegetable oils include but are not limited to: rapeseed oil, sunflower oil, soy bean oil, castor oil, peanut oil, grape seed oil, corn oil (e.g., including corn germ oil), canola oil, coconut oil, linseed oil, sesame oil, olive oil, palm oil, almond oil, avocado oil, china wood oil, cocoa oil, safflower oil, hemp seed oil, walnut oil, poppy seed oil, oiticaca oil (e.g., obtained by expression from the seeds of the Brazilian oiticaca tree, Licania rigida), palm nut oil, perilla oil, pecan oil, tung oil, and pine tar oil. If rapeseed oil is used, this can be in the amount of 50% or more by total weight of the composition.

For example, an exemplary composition of the invention comprises diethyl tartarate or triethyl citrate as the preferred ester-based hydroxycarboxy compounds, and either or both of these can be optionally combined with a conventional retarder, such as a sugar (e.g., gluconate, sucrose) and dispersed in a vegetable oil, such as rapeseed oil, in which the retarder:oil ratio can be 10:90 to 90:10 and more preferably 20:80 to 80:20, based on total weight of the composition.

In further embodiments, a vegetable oil derivative for dispersing the retarder actives may be selected from the group of mono and diglycerides of C₆-C₃₀ fatty acids, esters of C₆-C₃₀ fatty acids, ethoxylated compounds of C₆-C₃₀0 fatty acids, C₆-C₃₀ fatty alcohols, C₆-C₃₀ fatty amines, C₆-C₃₀ fatty amides, and tall oil derivatives.

As noted by Mauchamp et al., the list of potential vegetable oil and animal oil derivatives believed useful for purposes of the present invention is rather large. An exemplary list was in World Patent Application No. WO 85/05066 (International Publication No.) of Nielsen et al., International Patent Application No. PCT/CK85/00043, beginning at page 16; and these are also believed to be suitable for dispersing or otherwise carrying the ester-based hydroxycarboxy set retarder component of the present invention.

The derivatives include hexyl acetate, 2-ethylhexyl acetate, octyl acetate, isooctyl acetate, cetyl acetate, dodecyl acetate, tridecyl acetate; butyl butyrate, isobutyl butyrate, amyl isobutyrate, hexyl butyrate, heptyl butyrate, isoheptyl butyrate, octyl butyrate, isooctyl butyrate, 2-ethylhexyl butyrate, nonyl butyrate, isononyl butyrate, cetyl butyrate, isocetyl butyrate; ethyl hexanoate, propyl hexanoate, isopropyl hexanoate, butyl hexanoate, isobutyl hexanoate, amyl hexanoate, hexyl hexanoate, heptyl hexanoate, isoheptyl hexanoate, octyl hexanoate, 2-ethylhexyl hexanoate, nonyl hexanoate, isonynyl hexanoate, cetyl hexanoate, isocetyl hexanoate; methyl octanoate, ethyl octanoate, propyl octanoate, isopropyl octanoate, butyl octanoate, isobutyl octanoate, amyl octanoate, hexyl octanoate, heptyl octanoate, isoheptyl octanoate, octyl octanoate, isooctyl octanoate, 2-ethylhexyl octanoate, nonyl octanoate, isononyl octanoate, cetyl octanoate, isocetyl octanoate; methyl 2-ethylhexanoate, ethyl 2-ethylhexanoate, propyl 2-ethylhexanoate, isopropyl 2-ethylhexanoate, butyl 2-ethylhexanoate, isobutyl 2-ethylhexanoate, isoamyl 2-ethylhexanoate, hexyl 2-ethylhexanoate, heptyl 2-ethylhexanoate, isoheptyl 2-ethylhexanoate, octyl 2-ethylhexanoate, isooctyl 2-ethylhexanoate, 2-ethylhexyl 2-ethylhexanoate, nonyl 2-ethylhexanoate, isononyl 2-ethylhexanoate, cetyl 2-ethylhexanoate, isocetyl 2-ethylhexanoate; methyl decanoate, ethyl decanoate, propyl decanoate, isopropyl decanoate, butyl decanoate, isobutyl decanoate, isoamyl decanoate, hexyl decanoate, heptyl decanoate, isoheptyl decanoate, octyl decanoate, isooctyl decanoate, 2-ethylhexyl decanoate, nonyl decanoate, isononyl decanoate, cetyl decanoate, isocetyl decanoate; methyl laurate, ethyl laurate, propyl laurate, isopropyl laurate, butyl laurate, isobutyl laurate, isoamyl laurate, hexyl laurate, heptyl laurate, isoheptyl laurate, octyl laurate, isooctyl laurate, 2-ethylhexyl laurate, nonyl laurate, isononyl laurate, cetyl laurate, isocetyl laurate; ethyl oleate, propyl oleate, isopropyl oleate, butyl oleate, isobutyl oleate, isoamyl oleate, hexyl oleate, heptyl oleate, isoheptyl oleate, octyl oleate, isooctyl oleate, 2-ethylhexyl oleate, nonyl oleate, isononyl oleate, cetyl oleate, isocetyl oleate; diethyl succinate, dipropyl succinate, diisopropyl succinate, dibutyl succinate, diisobutyl succinate, diisoamyl succinate, dihexyl succinate, diheptyl succinate, diisoheptyl succinate, dioctyl succinate, diisooctyl succinate, di-2-ethylhexyl succinate, dinonyl succinate, diisononyl succinate, dicetyl succinate, diisocetyl succinate; dimethyl adipate, diethyl adipate, dipropyl adipate, diisopropyl adipate, dibutyl adipate, diisobutyl adipate, diisoamyl adipate, dihexyl adipate, diheptyl adipate, diisoheptyl adipate, dioctyl adipate, diisooctyl adipate, di-2-ethylhexyl adipate, dinonyl adipate, diisononyl adipate, dicetyl adipate, diisocetyl adipate; isopropyl myristate, isobutyl myristate, butyl myristate, amyl myristate, hexyl myristate, heptyl myristate, isoheptyl myristate, octyl myristate, 2-ethylhexyl myristate, nonyl myristate, isononyl myristate, cetyl myristate, isocetyl myristate; isopropyl palmitate, isobutyl palmitate, butyl palmitate, amyl palmitate, hexyl palmitate, heptyl palmitate, isoheptyl palmitate, octyl palmitate, 2-ethylhexyl palmitate, nonyl palmitate, isononyl palmitate, cetyl palmitate, isocetyl palmitate; isopropyl stearate, isobutyl stearate, butyl stearate, amyl stearate, hexyl stearate, heptyl stearate, isoheptyl stearate, octyl stearate, 2-ethylhexyl stearate, nonyl stearate, isononyl stearate, cetyl stearate, and isocetyl stearate.

Vegetable oils useful in the invention may be essential oils. The term “essential” means and refers to oils that contain the characteristic odor or flavor (i.e., the essence) of the original flower or fruit. An essential oil is usually obtained by steam distillation of the flowers or leaves or cold pressing of the skin or other parts (e.g., stem, flower, twigs, etc.). Exemplary essential oils include orange, grapefruit, lemon, citrus, and pinetree.

In other exemplary surface retarder compositions of the invention, the ester-based hydroxycarboxy set retarder compound can be dispersed in animal oil or its derivative, which can be used instead of, or in combination with, a vegetable oil or its derivative. The term “animal oil” refers to a product (whether oil, wax, or solid form) obtained from any animal substance, such as bone or other body component. Examples include lard oil, bone oil, herring oil, cod liver oil, neatsfoot oil, sardine oil, lanoline oil, fish oil, sheep wool oil, tallow oil, and bees wax. Derivatives of animal oils preferably include mono and diglycerides of C₆-C₃₀ fatty acids, esters of C₆-C₃₀ fatty acids, ethoxylated compounds of C₆-C₃₀ fatty acids, C₆-C₃₀ fatty alcohols, C₆-C₃₀ fatty amines, C₆-C₃₀ fatty amides, and tall oil derivatives. (See also list provided above in discussion of vegetable oil derivatives).

It is further contemplated that mixtures of animal oil and vegetable oil can be employed for various purposes. For example, pinetree oil can be used to cover or mask the smell of sheep wool oil. An exemplary surface retarder composition could comprise sunflower methylester (40%), sheep wool oil (25%), sucrose (9%), iron oxide ((2%), kieselguhr (22%), and pinetree oil (2%), all percentages based on total weight of the composition.

In further exemplary surface retarder compositions, the retarding actives may be dispersed in two or more different vegetable oils. Thus, for example, the actives may be dispersed or otherwise distributed within a continuous oil carrier phase comprising a vegetable oil as well as a vegetable oil derivative. The vegetable oil(s) and/or animal oil(s) function preferably as a continuous carrier phase within which to suspend or otherwise distribute one or more retarding actives dispersed throughout as a discontinuous phase.

In still further exemplary surface retarder compositions, the one or more ester-based set retarders may be combined with one or more conventional set retarders (e.g., sodium gluconate) in one or more oils.

Petroleum solvents and resins may also be employed to solvate or suspend the surface retarders, and these may be used alone or in combination with the afore-mentioned vegetal oils, mineral oils, and/or animal oils.

In further exemplary surface retarder compositions of the invention, optional compounds can be incorporated, such as fillers including calcium carbonate, silicon dioxide, sand, mica, talc, clay (e.g., kaolin), barium sulfate, sodium silico-aluminates, alumina, barium carbonate, dolomite (which is a carbonate of calcium and magnesium, CaMg(CO₃)₂), magnesium carbonate, magnesium oxide, kieslguhr (diatomaceous earth), or a mixture of any of the foregoing. The total filler content may be, for example, 0-50% based on total weight of the surface retarder composition.

Still further exemplary surface retarder compositions of the invention may also include one or more pigments, colorants, or dyes, such as titanium dioxide, iron oxide, chromium oxide, cobalt oxide, zinc oxide, carbon black, or other pigments or colorants, in an amount of 0-30% by total weight of the composition. It is desirable to employ at least one pigment, colorant, or dye such that an applicator can visually confirm, such as during a spray application, that a particular targeted cementitious surface has been treated with the surface retarder composition.

Other exemplary surface retarder compositions of the invention may additionally include other components, such as sorbitol, boric acid (or its salt), alkylphosphates, proteins, and casein. These may further components may be used for affecting various properties of the surface retarder compositions, such as rheology, viscosity, and/or surface tension. Accordingly, further embodiments include one or more rheology modifiers and/or viscosity modifiers.

Exemplary methods of the invention comprise applying a coating of the surface retarder compositions onto a hydratable cementitious material surface, such as concrete. The composition may be applied by roller but is preferably spray-applied directly to the surface to be treated. Subsequently, the treated surface portion may be washed away, using a pressure-washer or hose, to reveal an etched portion beneath the treated, removed surface portion.

Exemplary methods of the invention also include applying a coating of the surface retarder composition to the inside of a concrete mold, pouring concrete into the mold, and subsequently removing the molded concrete from the mold.

While the invention is described herein using a limited number of embodiments, these specific embodiments are not intended to limit the scope of the invention as otherwise described and claimed herein. Modification and variations from the described embodiments exist. More specifically, the following examples are given as a specific illustration of embodiments of the claimed invention. It should be understood that the invention is not limited to the specific details set forth in the examples. All parts and percentages in the examples, as well as in the remainder of the specification, are by percentage weight unless otherwise specified.

Further, any range of numbers recited in the specification or claims, such as that representing a particular set of properties, units of measure, conditions, physical states or percentages, is intended to literally incorporate expressly herein by reference or otherwise, any number falling within such range, including any subset of numbers within any range so recited. For example, whenever a numerical range with a lower limit, RL, and an upper limit RU, is disclosed, any number R falling within the range is specifically disclosed. In particular, the following numbers R within the range are specifically disclosed: R=RL+k*(RU-RL), where k is a variable ranging from 1% to 100% with a 1% increment, e.g., k is 1%, 2%, 3%, 4%, 5% . . . 50%, 51%, 52%, . . . 95%, 96%, 97%, 98%, 99%, or 100%. Moreover, any numerical range represented by any two values of R, as calculated above, is also specifically disclosed.

### EXAMPLE 1

A spray-applicable composition for use in retarding the surface of concrete was made by the following formulation: rapeseed oil (50.5%), methylester of rapeseed oil (40%), diethyltartarate (6%), titanium dioxide (3%), and fumed silica 0.5%). This formulation was obtained without having to grind any particulate materials, as would be the case if the acid forms (citric, tartaric) were employed. This composition was spray-applied at ambient temperature on fresh concrete at a rate of 200 grams per square meter. The composition was seen to perform satisfactorily when compared to using the acid forms, and provided an advantage in that the fog arising from spraying was not found to be irritating.

### EXAMPLE 2

The following formulation was found to be successful for use in spraying the inner surface of a form (concrete mold): colophon (30%), hydrocarbon solvent (48%) (Ebullition range: 100-160 degrees C.), triethylcitrate (10%), titanium dioxide (4%), and precipitate silica (8%). After dissolution of the colophon in hydrocarbon solvent, the rest of the formulation was dispersed at high speed with a mixer, but no grinding was required. This formulation was observed to perform well as a surface retarder in the concrete mold. Use of citric acid instead of triethylcitrate would have required a grinding procedure.

### EXAMPLE 3

A surface retarder composition was formulated using an ester-based surface retarder agent carried in a petroleum-based solvent. The following components were combined using the following temperatures and in the following amounts: aliphatic solvent (140° C.-160° C., BP:48%), petroleum resin (125° C., SP:23%), micronized mica (7%), titanium dioxide (2.4%), micronized talc (10%), and triethylcitrate (8%).

The foregoing example and embodiments were present for illustrative purposes only and not intended to limit the scope of the invention.

1. A method for retarding the surface of a concrete or other hydratable cementitious material, comprising spray-applying a surface-retarder composition onto a surface of a concrete or mortar or other hydratable cementitious material so as to retard the curing thereof or otherwise onto a surface of a mold into which a concrete or mortar or other hydratable cementitious material is placed; and subsequently removing a portion of the surface of said cementitious material on which said surface-retarder composition has been applied by spraying a jet of water to remove the retarded portion of the surface material or otherwise removing said cementitious material from said mold surface; said surface-retarder composition comprising at least one oil/solvent-soluble or oil-dispersible alkyl-ester-of-hydroxycarboxy compound contained in the form of particles or as a discontinuous liquid phase distributed within a continuous non-aqueous carrier phase which is spray-applicable in liquid form.

2. The method of claim 1 wherein said at least one oil/solvent-soluble or oil-dispersible alkyl-ester-of-hydroxycarboxy compound is selected from the group of alkyl-ester having an alpha-hydroxycarbonyl group and or alkyl-ester of a hydroxycarboxylic acid, or mixture thereof.

3. The method of claim 1 wherein said at least one oil/solvent-soluble or oil-dispersible alkyl-ester-of-hydroxycarboxy compound comprises an alkyl ester of citric acid, an alkyl ester of tartaric acid, an alkyl ester of malic acid, an alkyl ester of gallic acid, an alkyl ester of glycolic acid, an alkyl ester of gluconic acid, an alkyl ester of lactic acid, an alkyl ester of mandelic acid, an alkyl ester of salicylic acid, or an alkyl ester of 4-hydroxybutanoic acid.

4. The method of claim 1 wherein at least one oil/solvent-soluble or oil-dispersible alkyl-ester-of-hydroxycarboxy compound is an alkyl ester of citric acid.

5. The method of claim 4 wherein said alkyl ester of citric acid is triethyl citrate.

6. The method of claim 1 wherein said at least one oil/solvent-soluble or oil-dispersible alkyl-ester-of-hydroxycarboxy compound is an alkyl ester of tartaric acid.

7. The method of claim 6 wherein said alkyl ester of tartaric acid is diethyl tartarate.

8. The method of claim 1 wherein said at least one alkyl-ester-of-hydroxycarboxy compound is a mixture of triethyl citrate and diethyl tartarate.

9. The method of claim 1 further comprising: (A) at least one filler selected comprising calcium carbonate, silicon dioxide, sand, mica, talc, clay, barium sulfate, sodium silico-aluminate, alumina, barium carbonate, dolomite, magnesium carbonate, magnesium oxide, kieselghur (diatomaceous earth), or a mixture thereof; (B) at least one additive selected from the group consisting of a pigment, a colorant, or a dye comprising titanium dioxide, iron oxide, chromium oxide, cobalt oxide, zinc oxide, carbon black, or mixture thereof.

10. The method of claim 1 wherein said continuous non-aqueous carrier phase comprises a petroleum-based solvent, a vegetable oil, an animal oil, a mineral oil, or mixture or derivative of the foregoing.

11. The method of claim 10 wherein said at least one alkyl-ester-of-hydroxycarboxy compound comprises diethyl tartarate, triethyl citrate, or a mixture thereof contained in a solid particle form that is dispersed in a vegetable oil.

12. The method of claim 11 wherein said vegetable oil is rapeseed oil; and said composition further comprises titanium dioxide.

13. The method of claim 1 further comprising a conventional set retarder.

14. The method of claim 1 wherein said surface-retarder composition is spray-applied onto a surface of a concrete, mortar, or other hydratable cementitious composition and a portion of said surface is removed by spraying water.
